(19) United States
(12) Patent Application Publication
(10) Pub. No.: US 2026/0212616 A1
(43) Pub. Date: Jul. 23, 2026

(54) Machine-Learning Assisted Authoring of an Augmented Reality Experience

(71) Applicant: Niantic Spatial, Inc., San Francisco, CA (US)

(72) Inventors: Jaewook Lee, Seattle, WA (US); Filippo Aleotti, London (GB); Diego Mazala, London (GB); Guillermo Garcia-Hernando, London (GB); Sara Alexandra Gomes Vicente, London (GB); Gabriel J. Brostow, London (GB); Jessica Van Brummelen, London (GB)

(21) Appl. No.: 19/451,460

(22) Filed: Jan. 16, 2026

Related U.S. Application Data
(60) Provisional application No. 63/746,492, filed on Jan. 17, 2025.

(51) Int. Cl. G06T 19/00; G06F 3/04883; G06F 3/16; G06T 17/00

(52) U.S. Cl. CPC G06T 19/006; G06F 3/04883; G06F 3/167; G06T 17/00

(57) ABSTRACT

A device is disclosed for AI-assisted in-situ authoring of an augmented reality (AR) experience. The device captures, via a camera of the device, image data of a real-world site. The device presents the image data on a display of the device. The device accesses a spatial representation of the real-world site. The device receives user input to generate a virtual element for placement into an augmented reality experience. The device transmits the user input to an online system. The device receives the virtual element generated by the online system through execution of a generative model with a prompt based on the user input. The device generates the AR experience by placement of the virtual element informed by the spatial representation of the real-world site.

### CROSS-REFERENCE TO RELATED APPLICATION

The present application claims the benefit of and priority to U.S. Provisional Application No. 63/746,492 filed on January 17, 2025, which is incorporated by reference.

### BACKGROUND

### 1. Technical Field

The subject matter described relates generally to augmented reality (AR) experience generation.

### 2. Problem

When crafting an AR experience on-site, a developer may start with little to no information on the real-world site. The lack of information can make it difficult to begin generating the AR experience. Moreover, computing power can be limited when using a personal computing device (e.g., a mobile phone) on-site. Such limitations can make authoring the AR experience difficult.

### SUMMARY

The present disclosure describes a workflow for machine-learning assisted authoring of a site-specific AR experience. The in-situ user’s client device includes a camera assembly for capturing image data of the real-world site. The user may use their client device to capture image data of the real-world site. With the image data, a spatial representation of the real-world site may be generated (e.g., by the user’s client device or by a remote server). The spatial representation may be a mesh or a point cloud. The spatial representation may have additional scene understanding, e.g., segmentation of pixels for distinct objects, detection of objects, classification of objects, transient status of objects, etc. The client device further presents a user interface for engaging with machine-learning authoring-assistance tools. The user interface may include different options for user input. One option may include typing text, e.g., via an onscreen keyboard. Another option may include drawing text, e.g., via an onscreen notepad. Another option may include recording audio, e.g., via a microphone. The user input is leveraged in generating prompts to a large language model (LLM) for assistance of AR authoring. In one or more embodiments, the LLM may be leveraged in generating and/or modifying virtual elements for placement into the AR experience. In one or more embodiments, the LLM may be leveraged for modifying placement of virtual elements in the scene. In one or more embodiments, the LLM may be leveraged as part of an artificial intelligence (AI) agent, used in interacting with the user.

### BRIEF DESCRIPTION OF THE DRAWINGS

FIG. 1 illustrates a networked computing environment, according to one or more embodiments.

FIG. 2 depicts a representation of a virtual world having a geography that parallels the real world, according to one or more embodiments.

FIG. 3 depicts an exemplary game interface of a parallel reality game, according to one or more embodiments.

FIG. 4 illustrates a networked computing environment for machine-learning assisted authoring of an AR experience, according to one or more embodiments.

FIG. 5 illustrates an example user interface for in-situ authoring of an AR experience, according to one or more embodiments.

FIG. 6 illustrates an example workflow for scene understanding, according to one or more embodiments.

FIG. 7 illustrates an example workflow for LLM-assisted content generation, according to one or more embodiments.

FIG. 8 illustrates a method flowchart describing a process of AI-assisted on-site authoring of an AR experience, according to one embodiment.

FIG. 9 illustrates an example computer system suitable for use in training or applying a depth estimation model, according to one or more embodiments.

The figures and the following description describe certain embodiments by way of illustration only. One skilled in the art will readily recognize from the following description that alternative embodiments of the structures and methods may be employed without departing from the principles described. Reference will now be made to several embodiments, examples of which are illustrated in the accompanying figures.

### DETAILED DESCRIPTION

### EXEMPLARY LOCATION-BASED PARALLEL REALITY GAMING SYSTEM

Various embodiments are described in the context of a parallel reality game that includes augmented reality content in a virtual world geography that parallels at least a portion of the real-world geography such that player movement and actions in the real-world affect actions in the virtual world and vice versa. Those of ordinary skill in the art, using the disclosures provided herein, will understand that the subject matter described is applicable in other situations where determining depth information from image data is desirable. In addition, the inherent flexibility of computer-based systems allows for a great variety of possible configurations, combinations, and divisions of tasks and functionality between and among the components of the system. For instance, the systems and methods according to aspects of the present disclosure can be implemented using a single computing device or across multiple computing devices (e.g., connected in a computer network).

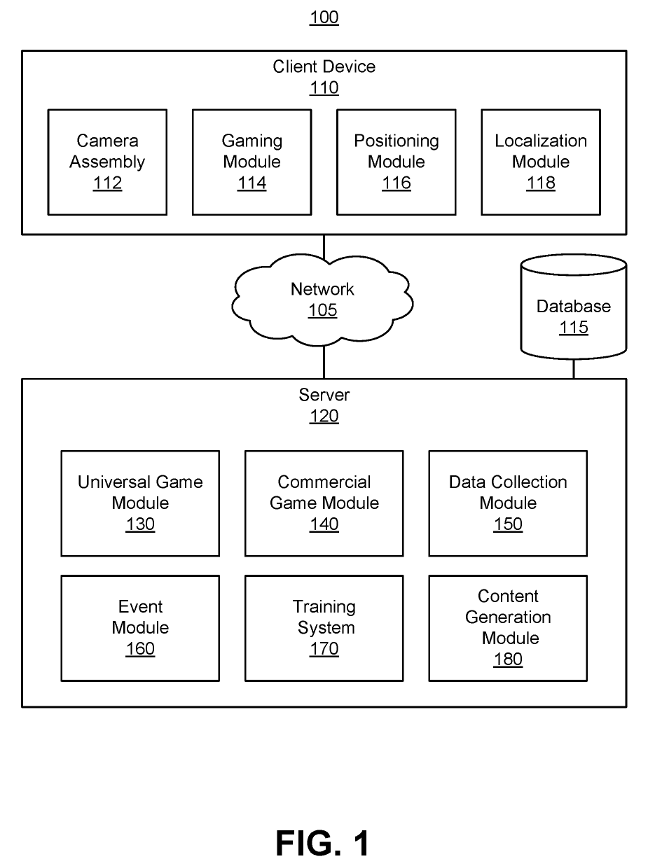

FIG. 1 illustrates a networked computing environment 100, according to one or more embodiments. The networked computing environment 100 provides for the interaction of players in a virtual world having a geography that parallels the real world. In particular, a geographic area in the real world can be linked or mapped directly to a corresponding area in the virtual world. A player can move about in the virtual world by moving to various geographic locations in the real world. For instance, a player’s position in the real world can be tracked and used to update the player’s position in the virtual world. Typically, the player’s position in the real world is determined by finding the location of a client device 110 through which the player is interacting with the virtual world and assuming the player is at the same (or approximately the same) location. For example, in various embodiments, the player may interact with a virtual element if the player’s location in the real world is within a threshold distance (e.g., ten meters, twenty meters, etc.) of the real-world location that corresponds to the virtual location of the virtual element in the virtual world. For convenience, various embodiments are described with reference to “the player’s location” but one of skill in the art will appreciate that such references may refer to the location of the player’s client device 110.

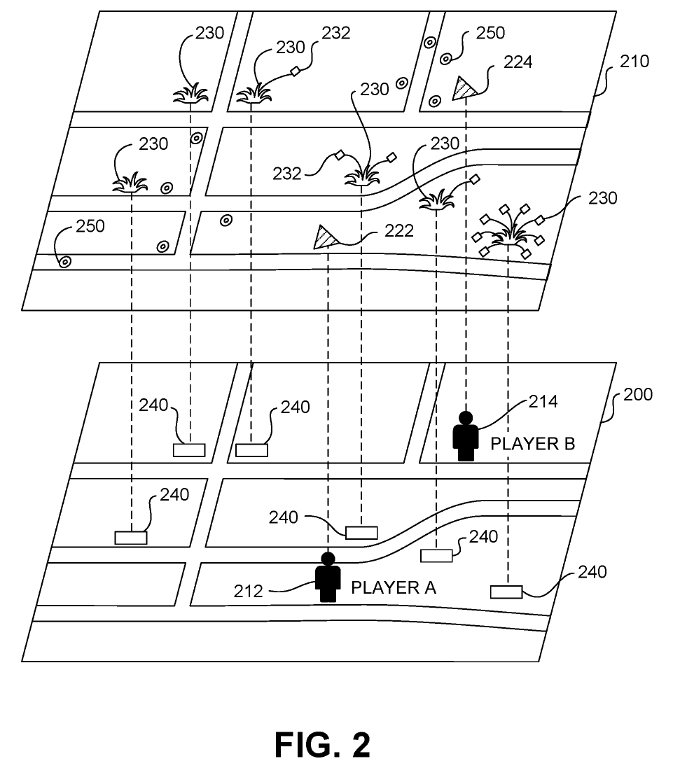

Reference is now made to FIG. 2 which depicts a conceptual diagram of a virtual world 210 that parallels the real world 200 that can act as the game board for players of a parallel reality game, according to one embodiment. As illustrated, the virtual world 210 can include a geography that parallels the geography of the real world 200. In particular, a range of coordinates defining a geographic area or space in the real world 200 is mapped to a corresponding range of coordinates defining a virtual space in the virtual world 210. The range of coordinates in the real world 200 can be associated with a town, neighborhood, city, campus, locale, a country, continent, the entire globe, or other geographic area. Each geographic coordinate in the range of geographic coordinates is mapped to a corresponding coordinate in a virtual space in the virtual world.

A player’s position in the virtual world 210 corresponds to the player’s position in the real world 200. For instance, the player A located at position 212 in the real world 200 has a corresponding position 222 in the virtual world 210. Similarly, the player B located at position 214 in the real world has a corresponding position 224 in the virtual world. As the players move about in a range of geographic coordinates in the real world, the players also move about in the range of coordinates defining the virtual space in the virtual world 210. In particular, a positioning system (e.g., a GPS system) associated with a mobile computing device carried by the player can be used to track a player’s position as the player navigates the range of geographic coordinates in the real world. Data associated with the player’s position in the real world 200 is used to update the player’s position in the corresponding range of coordinates defining the virtual space in the virtual world 210. In this manner, players can navigate along a continuous track in the range of coordinates defining the virtual space in the virtual world 210 by simply traveling among the corresponding range of geographic coordinates in the real world 200 without having to check in or periodically update location information at specific discrete locations in the real world 200.

The location-based game can include a plurality of game objectives requiring players to travel to and/or interact with various virtual elements and/or virtual objects scattered at various virtual locations in the virtual world. A player can travel to these virtual locations by traveling to the corresponding location of the virtual elements or objects in the real world. For instance, a positioning system can continuously track the position of the player such that as the player continuously navigates the real world, the player also continuously navigates the parallel virtual world. The player can then interact with various virtual elements and/or objects at the specific location to achieve or perform one or more game objectives.

For example, a game objective has players interacting with virtual elements 230 located at various virtual locations in the virtual world 210. These virtual elements 230 can be linked to landmarks, geographic locations, or objects 240 in the real world 200. The real-world landmarks or objects 240 can be works of art, monuments, buildings, businesses, libraries, museums, or other suitable real-world landmarks or objects. Interactions include capturing, claiming ownership of, using some virtual item, spending some virtual currency, etc. To capture these virtual elements 230, a player must travel to the landmark or geographic location 240 linked to the virtual elements 230 in the real world and must perform any necessary interactions with the virtual elements 230 in the virtual world 210. For example, player A of FIG. 2 may have to travel to a landmark 240 in the real world 200 in order to interact with or capture a virtual element 230 linked with that particular landmark 240. The interaction with the virtual element 230 can require action in the real world, such as taking a photograph and/or verifying, obtaining, or capturing other information about the landmark or object 240 associated with the virtual element 230.

Game objectives may require that players use one or more virtual items that are collected by the players in the location-based game. For instance, the players may travel the virtual world 210 seeking virtual items (e.g., weapons, creatures, power ups, or other items) that can be useful for completing game objectives. These virtual items can be found or collected by traveling to different locations in the real world 200 or by completing various actions in either the virtual world 210 or the real world 200. In the example shown in FIG. 2, a player uses virtual items 232 to capture one or more virtual elements 230. In particular, a player can deploy virtual items 232 at locations in the virtual world 210 proximate or within the virtual elements 230. Deploying one or more virtual items 232 in this manner can result in the capture of the virtual element 230 for the particular player or for the team/faction of the particular player.

In one particular implementation, a player may have to gather virtual energy as part of the parallel reality game. As depicted in FIG. 2, virtual energy 250 can be scattered at different locations in the virtual world 210. A player can collect the virtual energy 250 by traveling to the corresponding location of the virtual energy 250 in the actual world 200. The virtual energy 250 can be used to power virtual items and/or to perform various game objectives in the game. A player that loses all virtual energy 250 can be disconnected from the game.

According to aspects of the present disclosure, the parallel reality game can be a massive multi-player location-based game where every participant in the game shares the same virtual world. The players can be divided into separate teams or factions and can work together to achieve one or more game objectives, such as to capture or claim ownership of a virtual element. In this manner, the parallel reality game can intrinsically be a social game that encourages cooperation among players within the game. Players from opposing teams can work against each other (or sometime collaborate to achieve mutual objectives) during the parallel reality game. A player may use virtual items to attack or impede progress of players on opposing teams. In some cases, players are encouraged to congregate at real world locations for cooperative or interactive events in the parallel reality game. In these cases, the game server seeks to ensure players are indeed physically present and not spoofing.

The parallel reality game can have various features to enhance and encourage game play within the parallel reality game. For instance, players can accumulate a virtual currency or another virtual reward (e.g., virtual tokens, virtual points, virtual material resources, etc.) that can be used throughout the game (e.g., to purchase in-game items, to redeem other items, to craft items, etc.). Players can advance through various levels as the players complete one or more game objectives and gain experience within the game. In some embodiments, players can communicate with one another through one or more communication interfaces provided in the game. Players can also obtain enhanced “powers” or virtual items that can be used to complete game objectives within the game. Those of ordinary skill in the art, using the disclosures provided herein, should understand that various other game features can be included with the parallel reality game without deviating from the scope of the present disclosure.

Referring back FIG. 1, the networked computing environment 100 uses a client-server architecture, where a server 120 communicates with a client device 110 over a network 105, e.g., to provide a parallel reality game to players at the client device 110. The networked computing environment 100 may provide other computer functionality, e.g., generating virtual content in part by the server 120 for distribution to the client device 110, or generating navigational instructions by the server 120 for controlling operation of a client device 110 embodied as an autonomous agent. The networked computing environment 100 also may include other external systems such as other content creation systems or business systems. Although only one client device 110 is illustrated in FIG. 1, any number of clients 110 or other external systems may be connected to the server 120 over the network 105. Furthermore, the networked computing environment 100 may contain different or additional elements and functionality may be distributed between the client device 110 and the server 120 in a different manner than described below.

A client device 110 can be any portable computing device that can be used by a player to interface with the server 120. For instance, a client device 110 can be a wireless device, a personal digital assistant (PDA), portable gaming device, cellular phone, smart phone, tablet, navigation system, handheld GPS system, wearable computing device, a display having one or more processors, or other such device. In another instance, the client device 110 includes a conventional computer system, such as a desktop or a laptop computer. Still yet, the client device 110 may be a vehicle with a computing device. In short, a client device 110 can be any computer device or system that can enable a player to interact with the server 120. As a computing device, the client device 110 can include one or more processors and one or more computer-readable storage media. The computer-readable storage media can store instructions which cause the processor to perform operations. The client device 110 is preferably a portable computing device that can be easily carried or otherwise transported with a player, such as a smartphone or tablet.

In an embodiment, the client device executes an application allowing the user of the client device 110 to interact with the server 120 or other components of the system environment 100. For example, a client device 110 can execute an application associated with the parallel reality game to enable interaction between the client device 110 and the server 120 or other components of the system environment 100 via the network 105. In another embodiment, the client device 110 interacts with the server 120 or other components of the system environment 100 through an application programming interface (API) running on a native operating system of the client device 110, such as IOS® or ANDROID™.

In one or more embodiments, the client device 110 communicates with the server 120, providing the server 120 with sensory data of a physical environment. The client device 110 includes a camera assembly 112 that captures image data in two dimensions of a scene in the physical environment where the client device 110 is located. In the embodiment shown in FIG. 1, each client device 110 includes components such as a gaming module 114, a positioning module 116, and a localization module 118. The client device 110 may include various other input/output devices for receiving information from and/or providing information to a player. Example input/output devices include a display screen, a touchscreen, a touch pad, data entry keys, speakers, and a microphone suitable for voice recognition. The client device 110 may also include additional sensors for recording data from the environment of the client device 110, the sensors including but not limited to, movement sensors, accelerometers, gyroscopes, other inertial measurement units (IMUs), barometers, positioning systems, thermometers, light sensors, microphones, etc.

The client device 110 can further include a network interface (not shown) for providing communications over the network 105. A network interface can include any suitable components for interfacing with one more networks, including for example, transmitters, receivers, ports, controllers, antennas, or other suitable components.

The camera assembly 112 captures image data of a scene of the environment where the client device 110 is in. The camera assembly 112 may utilize a variety of varying photo sensors with varying color capture ranges at varying capture rates. The camera assembly 112 may contain a wide-angle lens or a telephoto lens. The camera assembly 112 may be configured to capture single images or video as the image data. Additionally, the orientation of the camera assembly 112 could be parallel to the ground with the camera assembly 112 aimed at the horizon. The camera assembly 112 captures image data and shares the image data with the computing device on the client device 110. The image data can be appended with metadata describing other details of the image data including sensory data (e.g., temperature, brightness of environment) or capture data (e.g., exposure, warmth, shutter speed, focal length, capture time, etc.). The camera assembly 112 can include one or more cameras which can capture image data. In one instance, the camera assembly 112 comprises one camera and is configured to capture monocular image data. In another instance, the camera assembly 112 comprises two cameras and is configured to capture stereoscopic image data. In various other implementations, the camera assembly 112 comprises a plurality of cameras each configured to capture image data. Each camera of the camera assembly 126 may append each image with metadata, e.g., including camera parameters such as lens focal length, shutter speed, exposure values, etc.

The gaming module 114 provides a player with an interface to participate in the parallel reality game. The server 120 transmits game data over the network 105 to the client device 110 for use by the gaming module 114 at the client device 110 to provide local versions of the game to players at locations remote from the server 120. The server 120 can include a network interface for providing communications over the network 105. A network interface can include any suitable components for interfacing with one more networks, including for example, transmitters, receivers, ports, controllers, antennas, or other suitable components.

The gaming module 114 executed by the client device 110 provides an interface between a player and the parallel reality game. The gaming module 114 can present a user interface on a display device associated with the client device 110 that displays a virtual world (e.g., renders imagery of the virtual world) associated with the game and allows a user to interact in the virtual world to perform various game objectives. In some other embodiments, the gaming module 114 presents image data from the real world (e.g., captured by the camera assembly 112) augmented with virtual elements from the parallel reality game. In these embodiments, the gaming module 114 may generate virtual content and/or adjust virtual content according to other information received from other components of the client device 110. For example, the gaming module 114 may adjust a virtual object to be displayed on the user interface according to a depth map of the scene captured in the image data.

In one or more embodiments, the gaming module 114 may present a digitized spatial representation of a real-world scene. In such embodiments, the spatial representation may be previously generated from image data comprising a plurality of image frames of the real-world scene. The digitized spatial representation may capture the spatial structure of objects in the real-world scene. The representation may further include visual characteristics of the objects mapped onto the volumetric reconstruction. The visual characteristics may include a texture, a pattern, a coloration, topographical features, other visual features. In some embodiments, the gaming module 114 may adjust rendering on a display of the client device 110 based on a pose of the client device 110. For example, a player may move around the digitized spatial representation with their client device 110. Based on the movement, i.e., the changed pose of the client device 110, the gaming module 114 may update a perspective of the digitized spatial representation. Accordingly, the gaming module 114 may leverage the pose, e.g., from the localization module 118.

The gaming module 114 can also control various other outputs to allow a player to interact with the game without requiring the player to view a display screen. For instance, the gaming module 114 can control various audio, vibratory, or other notifications that allow the player to play the game without looking at the display screen. The gaming module 114 can access game data received from the server 120 to provide an accurate representation of the game to the user. The gaming module 114 can receive and process player input and provide updates to the server 120 over the network 105. The gaming module 114 may also generate and/or adjust game content to be displayed by the client device 110. For example, the gaming module 114 may generate a virtual element based on depth information.

The positioning module 116 can be any device or circuitry for monitoring the position of the client device 110. For example, the positioning module 116 can determine actual or relative position by using a satellite navigation positioning system (e.g. a GPS system, a Galileo positioning system, the Global Navigation satellite system (GLONASS), the BeiDou Satellite Navigation and Positioning system), an inertial navigation system, a dead reckoning system, based on IP address, by using triangulation and/or proximity to cellular towers or Wi-Fi hotspots, and/or other suitable techniques for determining position. The positioning module 116 may further include various other sensors that may aid in accurately positioning the client device 110 location.

As the player moves around with the client device 110 in the real world, the positioning module 116 tracks the position of the player and provides the player position information to the gaming module 114. The gaming module 114 updates the player position in the virtual world associated with the game based on the actual position of the player in the real world. Thus, a player can interact with the virtual world simply by carrying or transporting the client device 110 in the real world. In particular, the location of the player in the virtual world can correspond to the location of the player in the real world. The gaming module 114 can provide player position information to the server 120 over the network 105. In response, the server 120 may enact various techniques to verify the client device 110 location to prevent cheaters from spoofing the client device 110 location. It should be understood that location information associated with a player is utilized only if permission is granted after the player has been notified that location information of the player is to be accessed and how the location information is to be utilized in the context of the game (e.g., to update player position in the virtual world). In addition, any location information associated with players will be stored and maintained in a manner to protect player privacy.

The localization module 118 provides an additional or alternative way to determine the location of the client device 110. In one embodiment, the localization module 118 receives the location determined for the client device 110 by the positioning module 116 and refines it by determining a pose of one or more cameras of the camera assembly 112. The localization module 118 may use the location generated by the positioning module 116 to select a 3D map of the environment surrounding the client device 110 and localize against the 3D map. The localization module 118 may obtain the 3D map from local storage or from the server 120. The 3D map may be a point cloud, mesh, or any other suitable 3D representation of the environment surrounding the client device 110. Alternatively, the localization module 118 may determine a location or pose of the client device 110 without reference to a coarse location (such as one provided by a GPS system), such as by determining the relative location of the client device 110 to another device.

In one embodiment, the localization module 118 applies a trained relocalizer model (as an embodiment of a localization model) to determine the pose of images captured by the camera assembly 112 relative to the 3D map. Thus, the relocalizer model can determine an accurate (e.g., to within a few centimeters and degrees) determination of the position (e.g., up to three degrees of translational freedom) and orientation (e.g., up to three degrees of rotational freedom) of the client device 110. The position of the client device 110 can then be tracked over time using dead reckoning based on sensor readings, periodic re-localization, or a combination of both. Having an accurate pose for the client device 110 may enable the gaming module 114 to present virtual content overlaid on images of the real world (e.g., by displaying virtual elements in conjunction with a real-time feed from the camera assembly 112 on a display) or the real world itself (e.g., by displaying virtual elements on a transparent display of an AR headset) in a manner that gives the impression that the virtual objects are interacting with the real world. For example, a virtual character may hide behind a real tree, a virtual hat may be placed on a real statue, or a virtual creature may run and hide if a real person approaches it too quickly.

The server 120 can be any computing device and can include one or more processors and one or more computer-readable storage media. The computer-readable storage media can store instructions which cause the processor to perform operations. The server 120 can include or can be in communication with a database 115. The database 115 stores game data used in the parallel reality game to be served or provided to the client(s) 110 over the network 105.

The game data stored in the database 115 can include: (1) data associated with the virtual world in the parallel reality game (e.g. imagery data used to render the virtual world on a display device, geographic coordinates of locations in the virtual world, etc.); (2) data associated with players of the parallel reality game (e.g. player profiles including but not limited to player information, player experience level, player currency, current player positions in the virtual world/real world, player energy level, player preferences, team information, faction information, etc.); (3) data associated with game objectives (e.g. data associated with current game objectives, status of game objectives, past game objectives, future game objectives, desired game objectives, etc.); (4) data associated virtual elements in the virtual world (e.g. positions of virtual elements, types of virtual elements, game objectives associated with virtual elements; corresponding actual world position information for virtual elements; behavior of virtual elements, relevance of virtual elements etc.); (5) data associated with real-world objects, landmarks, positions linked to virtual-world elements (e.g. location of real-world objects/landmarks, description of real-world objects/landmarks, relevance of virtual elements linked to real-world objects, etc.); (6) Game status (e.g. current number of players, current status of game objectives, player leaderboard, etc.); (7) data associated with player actions/input (e.g. current player positions, past player positions, player moves, player input, player queries, player communications, etc.); and (8) any other data used, related to, or obtained during implementation of the parallel reality game. The game data stored in the database 115 can be populated either offline or in real time by system administrators and/or by data received from users/players of the system 100, such as from a client device 110 over the network 105.

The server 120 can be configured to receive requests for game data from a client device 110 (for instance via remote procedure calls (RPCs)) and to respond to those requests via the network 105. For instance, the server 120 can encode game data in one or more data files and provide the data files to the client device 110. In addition, the server 120 can be configured to receive game data (e.g. player positions, player actions, player input, etc.) from a client device 110 via the network 105. For instance, the client device 110 can be configured to periodically send player input and other updates to the server 120, which the server 120 uses to update game data in the database 115 to reflect any and all changed conditions for the game.

In the embodiment shown, the server 120 includes a universal game module 130, a commercial game module 140, a data collection module 150, an event module 160, and a training system 170. As mentioned above, the server 120 interacts with a database 115 that may be part of the server 120 or accessed remotely (e.g., the database 115 may be a distributed database accessed via the network 105). In other embodiments, the server 120 contains different and/or additional elements. In addition, the functions may be distributed among the elements in a different manner than described. For instance, the database 115 can be integrated into the server 120.

The universal game module 130 hosts the parallel reality game for all players and acts as the authoritative source for the current status of the parallel reality game for all players. As the host, the universal game module 130 generates game content for presentation to players, e.g., via their respective client devices 110. The universal game module 130 may access the database 115 to retrieve and/or store game data when hosting the parallel reality game. The universal game module 130 also receives game data from client device 110 (e.g. depth information, player input, player position, player actions, landmark information, etc.) and incorporates the game data received into the overall parallel reality game for all players of the parallel reality game. The universal game module 130 can also manage the delivery of game data to the client device 110 over the network 105. The universal game module 130 may also govern security aspects of client device 110 including but not limited to securing connections between the client device 110 and the server 120, establishing connections between various client device 110, and verifying the location of the various client device 110.

The commercial game module 140, in embodiments where one is included, can be separate from or a part of the universal game module 130. The commercial game module 140 can manage the inclusion of various game features within the parallel reality game that are linked with a commercial activity in the real world. For instance, the commercial game module 140 can receive requests from external systems such as sponsors/advertisers, businesses, or other entities over the network 105 (via a network interface) to include game features linked with commercial activity in the parallel reality game. The commercial game module 140 can then arrange for the inclusion of these game features in the parallel reality game.

The server 120 can further include a data collection module 150. The data collection module 150, in embodiments where one is included, can be separate from or a part of the universal game module 130. The data collection module 150 can manage the inclusion of various game features within the parallel reality game that are linked with a data collection activity in the real world. For instance, the data collection module 150 can modify game data stored in the database 115 to include game features linked with data collection activity in the parallel reality game. The data collection module 150 can also analyze and data collected by players pursuant to the data collection activity and provide the data for access by various platforms.

The event module 160 manages player access to events in the parallel reality game. Although the term “event” is used for convenience, it should be appreciated that this term need not refer to a specific event at a specific location or time. Rather, it may refer to any provision of access-controlled game content where one or more access criteria are used to determine whether players may access that content. Such content may be part of a larger parallel reality game that includes game content with less or no access control or may be a stand-alone, access controlled parallel reality game.

The training system 170 trains one or more models implemented by the client device 110 and/or the server 120. To train models, the training system 170 may obtain training data from one or more sources. The training data may be labeled (i.e., for supervised training), unlabeled (i.e., for unsupervised training), or some combination thereof (i.e., for semi-supervised training). Once trained, the training system 170 may validate the efficacy of the one or more models. The training system 170 may further fine tune (i.e., retrain) the one or more models based on validation data. In one or more embodiments, the training system 170 may train relocalizer model for estimating a camera pose of an input image, in reference to reconstructed physical scene in the real-world. In other embodiments, a relocalizer model may be deployed on the client device 110. The trained relocalizer model may be provided to the client device 110 and the localization module 118 may include functionality to load and initialize the relocalizer model on the client device 110 to perform inference.

The content generation module 180 generates content for presentation to the client device 110. In one or more embodiments, the content generation module 180 may be used to generate virtual reality, mixed reality, augmented reality content, or other artificial reality content.

In one or more embodiments of generating augmented reality content, the content generation module 180 generates virtual elements to overlay onto images captured of real-world environments or scenes. The content generation module 180 may generate the virtual element based on information on the images, e.g., pose, camera calibration, depth, image features, etc. In some embodiments, the pose may be used in other image featurization models, e.g., a depth estimation model configured to input an image and its pose to output a depth map for the image. The depth map may inform depth of various objects in the image, e.g., for generating virtual content that is at least partially occluded.

In one or more embodiments, the content generation module 180 may generate a digitized spatial representation of a physical scene. To create the digitized spatial representation, the content generation module 180 reconstructs volumetric representations of real-world objects in the physical scene. The content generation module 180 may form the volumetric representations based on pose information on the image data and, optionally, associated depth information. For example, the content generation module 180 may implement a truncated signed distance function (TSDF) to integrate depth maps with known pose to generate a three-dimensional (3D) voxel array representing surfaces of objects in the real-world scene. The content generation module 180 may further extract a polygon mesh from the 3D voxel array to represent the surfaces via discretizing polygons. The content generation module 180 may further augment the spatial representation with visual characteristics of the objects, obtained from the image data. The content generation module 180 may store the generated spatial representations in the database 115. At a later time, the content generation module 180 may update or refine the spatial representation of the real-world scene with additional image data on the scene. In some embodiments, the content generation module 180 may generate virtual elements to interact with the digitized spatial representation. For example, the content generation module 180 may overlay virtual characters, virtual modifications, etc. The server 120 may provide the digitized spatial representation, optionally with virtual elements, to the client device 110 for presentation to the user.

In some embodiments, the content generation module 180 may generate navigational instructions for navigating a traversable agent within an environment. In such embodiments, the client device 110 may be the traversable agent, e.g., an autonomous vehicle. Based on its movement mode, the content generation module 180 may generate control instructions to control operation of one or more actuator assemblies to move the traversable agent. The content generation module 180 may receive sensory data of the environment, e.g., image data (and associated data), depth information, etc. The content generation module 180 (or the client device 110) may further implement models to extract additional features from the sensory data, e.g., implementing a trained relocalizer model to output poses for the images of the image data. The content generation module 180 may further implement a depth estimation model to output depth information for the images of the image data. The content generation module 180 may further implement other models, an object detection model for identifying and/or recognizing objects in the image data, a semantic segmentation model for segregating pixels into different pixel categorizations (e.g., objects, ground, sky, buildings, transient or moving objects, etc.), etc. Based on the information deduced from the sensory data, the content generation module 180 may determine the navigational route of the traversable agent. In some embodiments, the content generation module 180 may provide the navigational instructions to the client device 110. In other embodiments, the content generation module 180 may generate control instructions to control the movement of the traversable agent.

The network 105 can be any type of communications network, such as a local area network (e.g. intranet), wide area network (e.g. Internet), or some combination thereof. The network can also include a direct connection between a client device 110 and the server 120. In general, communication between the server 120 and a client device 110 can be carried via a network interface using any type of wired and/or wireless connection, using a variety of communication protocols (e.g. TCP/IP, HTTP, SMTP, FTP), encodings or formats (e.g. HTML, XML, JSON), and/or protection schemes (e.g. VPN, secure HTTP, SSL).

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

In addition, in-situations in which the systems and methods discussed herein access and analyze personal information about users, or make use of personal information, such as location information, the users may be provided with an opportunity to control whether programs or features collect the information and control whether and/or how to receive content from the system or other application. No such information or data is collected or used until the user has been provided meaningful notice of what information is to be collected and how the information is used. The information is not collected or used unless the user provides consent, which can be revoked or modified by the user at any time. Thus, the user can have control over how information is collected about the user and used by the application or system. In addition, certain information or data can be treated in one or more ways before it is stored or used, so that personally identifiable information is removed. For example, a user’s identity may be treated so that no personally identifiable information can be determined for the user.

### EXEMPLARY GAME INTERFACE

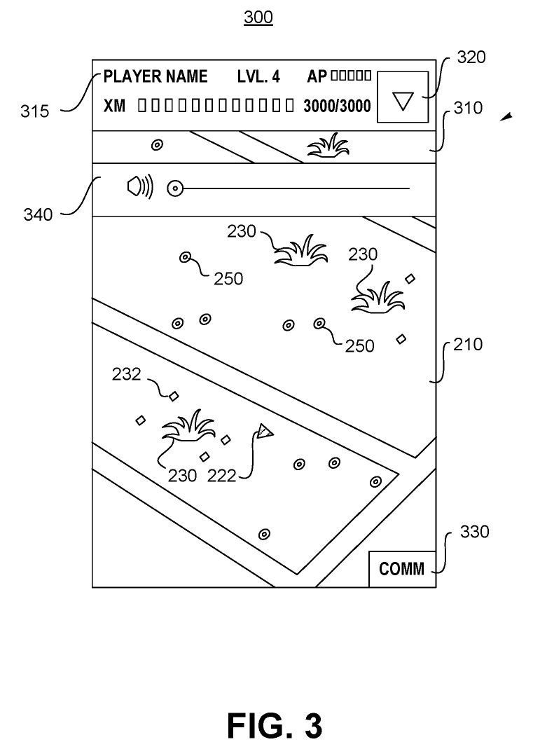

FIG. 3 depicts one embodiment of a game interface 300 that can be presented on a display of a client as part of the interface between a player and the virtual world 210. The game interface 300 includes a display window 310 that can be used to display the virtual world 210 and various other aspects of the game, such as player position 222 and the locations of virtual elements 230, virtual items 232, and virtual energy 250 in the virtual world 210. The user interface 300 can also display other information, such as game data information, game communications, player information, client location verification instructions and other information associated with the game. For example, the user interface can display player information 315, such as player name, experience level and other information. The user interface 300 can include a menu 320 for accessing various game settings and other information associated with the game. The user interface 300 can also include a communications interface 330 that enables communications between the game system and the player and between one or more players of the parallel reality game.

According to aspects of the present disclosure, a player can interact with the parallel reality game by simply carrying a client device 110 around in the real world. For instance, a player can play the game by simply accessing an application associated with the parallel reality game on a smartphone and moving about in the real world with the smartphone. In this regard, it is not necessary for the player to continuously view a visual representation of the virtual world on a display screen in order to play the location-based game. As a result, the user interface 300 can include a plurality of non-visual elements that allow a user to interact with the game. For instance, the game interface can provide audible notifications to the player when the player is approaching a virtual element or object in the game or when an important event happens in the parallel reality game. A player can control these audible notifications with audio control 340. Different types of audible notifications can be provided to the user depending on the type of virtual element or event. The audible notification can increase or decrease in frequency or volume depending on a player’s proximity to a virtual element or object. Other non-visual notifications and signals can be provided to the user, such as a vibratory notification or other suitable notifications or signals.

Those of ordinary skill in the art, using the disclosures provided herein, will appreciate that numerous game interface configurations and underlying functionalities will be apparent in light of this disclosure. The present disclosure is not intended to be limited to any one particular configuration.

### ML-ASSISTED AUTHORING OF AN AR EXPERIENCE

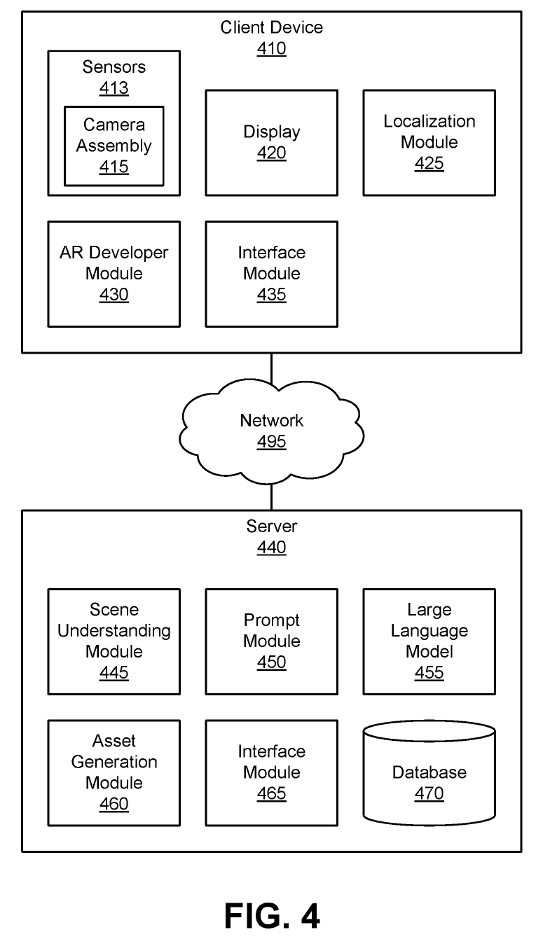

FIG. 4 illustrates a networked computing environment for ML-assisted authoring of an AR experience, according to one or more embodiments. The networked computing environment provides for the interaction of at least one user, operating a client device 410, with a server 440, via the network 495. The user is the author of the AR experience. The server 440 provides data useful for the AR experience authoring. For convenience, various embodiments are described with reference to “the user’s location” but one of skill in the art will appreciate that such references may refer to the location of the user’s client device.

A user operates a client device 410 to author an AR experience. In one or more embodiments, the user may be on-site (i.e., in-situ) authoring the AR experience. In other embodiments, the user may be off-site (i.e., ex-situ). The client device 410 may include one or more sensors 413 (e.g., inclusive of a camera assembly 415), a display 420, a localization module 425, an AR developer module 430, and an interface module 435. In other embodiments, the user client device 410 may include additional components, e.g., other input and/or output devices. For example, the user client device 410 may include a microphone for capturing audio, an audio speaker for presenting audio, etc.

The camera assembly 415 captures image data of the environment. The camera assembly 415 may include one or more cameras. Image data captured by the camera assembly 415 may be augmented with virtual content, thereby generating AR content. In some embodiments, the camera assembly 415 include at least two cameras, with one camera facing one direction (e.g., on the backside of a mobile phone), and another camera facing an opposite direction (e.g., on the frontside of the mobile phone). Each camera may include one or more optical elements for directing and focusing light from the environment onto an imaging sensor that converts the incident light into a digital signal, forming a digital image.

The display 420 presents visual content. The display 420 may present a live feed of the camera assembly 415. The display 420 may further present AR content augmented onto the live feed, e.g., via the AR developer module 430. In various embodiments, the display 420 may be an integrated touchscreen configured to detect user input via capacitive, resistive, optical, ultrasonic, or other sensing modalities, and may support single- or multi-touch, stylus, and gesture interactions. Alternatively or additionally, the display 420 may be a non-touch monitor, panel, or screen, including but not limited to LCD, LED, OLED, microLED, plasma, CRT, e-paper/e-ink, projection surfaces, head-up displays, and head-mounted or near-eye displays (e.g., AR/VR). The display 420 may be internal to the device (e.g., a smartphone, tablet, or laptop) or external (e.g., a desktop monitor, television, kiosk, or digital signage), and may be connected via wired interfaces (e.g., HDMI, DisplayPort, USB-C, LVDS, MIPI) and/or wireless links (e.g., Wi-Fi-based casting, Miracast, AirPlay, Bluetooth). The display 420 may have any suitable size, resolution, aspect ratio, color depth, refresh rate, brightness, and orientation, and may operate as one of multiple displays in mirrored or extended configurations. In some embodiments, the display 420 includes or interfaces with a display controller, backlight, driver circuitry, and sensors such as ambient light, proximity, and orientation sensors, and may provide haptic output. The display 420 may be foldable, rollable, detachable, or remote (e.g., streamed), and may render graphical user interfaces, video, images, and text associated with operation of the user device.

In one or more embodiments, the client device 410 includes an inertial measurement unit (IMU). The IMU is configured to capture motion data describing motion of the user device. In various embodiments, the IMU includes one or more accelerometers and gyroscopes, and optionally magnetometers and barometric sensors, sampled at configurable rates with synchronized timestamps to produce raw linear acceleration, angular rate, and magnetic field measurements. The IMU may include on-board or host-executed signal processing that performs filtering (e.g., low-pass, high-pass, notch), bias and scale-factor correction, temperature compensation, and sensor fusion (e.g., complementary or Kalman filtering) to estimate device attitude (e.g., quaternion, rotation matrix, Euler angles), gravity-compensated linear acceleration, and angular velocity in device and/or world coordinate frames. The IMU may perform continuous or event-driven motion detection, including thresholded wake-on-motion, step or stride detection, gesture or tap recognition, and stationary versus dynamic state classification, and may transform measurements between sensor, device, and application reference frames using stored calibration and alignment parameters. In some embodiments, the IMU supports dead reckoning and pose tracking, provides disturbance detection (e.g., magnetic anomalies, shock events) and outlier rejection, and combines its outputs with auxiliary signals (e.g., GNSS, camera-based visual odometry, wheel encoders, or Wi-Fi/Bluetooth ranging) to improve accuracy and robustness. In certain implementations, the IMU operates in multiple modes (e.g., high-accuracy, low-power, game/AR), selected based on application requirements to balance precision, responsiveness, and resource usage.

In various embodiments, the client device 410 includes a global positioning system receiver configured to determine global positioning coordinates of the client device 410. The global positioning system receiver may include a radiofrequency (RF) front end (e.g., antenna, low-noise amplifier, filters) and baseband processor configured to acquire and track satellite signals, correlate received waveforms with known pseudo-random noise codes, and extract navigation data (e.g., ephemeris, almanac, timing) from one or more satellites to determine global positioning coordinates. The receiver estimates code phase and carrier frequency using tracking loops (e.g., delay-locked, frequency-locked, phase-locked) to produce pseudorange and Doppler measurements, computes satellite positions from ephemerides, and performs trilateration while jointly solving for receiver clock bias to yield latitude, longitude, altitude, and optionally velocity and heading. In some implementations, the receiver supports multiple constellations and frequencies (e.g., GPS L1/L2/L5, GLONASS, Galileo, BeiDou), applies atmospheric models and error corrections, and leverages augmentation systems (e.g., SBAS, differential GPS, RTK) and assisted-GPS aiding (e.g., network-provided time, ephemeris, coarse location) to improve accuracy, convergence time, and availability. The receiver may implement multipath and interference mitigation, quality estimation (e.g., SNR, DOP, fix type, confidence bounds), and sensor fusion with inertial inputs for continuity during signal blockage. The receiver exposes standardized interfaces for configuration and data output (e.g., NMEA sentences or binary messages) and may provide timestamped coordinates aligned to GPS time or UTC, along with diagnostics and integrity indicators.

In various embodiments, the client device 410 includes an acoustic sensor assembly configured to capture acoustic signals for voice input, communication, and ambient sound sensing. The acoustic sensor assembly may employ one or more microphones, e.g., analog or digital MEMS transducers with omnidirectional or directional patterns, coupled to an analog front end (e.g., low-noise amplifier, biasing, anti-alias filter) and an analog-to-digital converter, or implemented as digital microphones providing pulse-density modulation or I2S/TDM outputs. The microphone may operate at selectable sample rates and bit depths, and can be arranged in arrays to support beamforming, spatial filtering, and direction-of-arrival estimation. Signal processing on-device may include automatic gain control, noise suppression, echo cancellation, wind and handling noise mitigation, de-reverberation, voice activity detection, and wake-word or keyword spotting, with configurable latency and power profiles. Placement and calibration strategies (e.g., sensitivity matching, phase alignment, temperature and aging compensation) can improve fidelity across device orientations and use cases, and adaptive algorithms may adjust parameters based on ambient conditions.

In various embodiments, the client device 410 includes an audio speaker configured to render acoustic output from a user device. The audio speaker may include one or more electroacoustic transducers such as dynamic drivers (moving-coil), balanced armature elements, planar magnetic or piezoelectric actuators, bone-conduction emitters, or micro-speaker arrays, arranged as single- or multi-way systems with passive or active crossovers. The audio speaker may be mounted in an engineered enclosure (e.g., sealed, vented/ported, transmission line, or with a passive radiator) with acoustic labyrinths, gaskets, and meshes to control resonance, reduce distortion, improve low-frequency extension, and provide environmental protection (e.g., water-resistant membranes and debris filters). The system may cooperate with microphones to support echo reference for voice capture and optional active noise control, and can run calibration or self-test routines (e.g., impulse response, sweep-based diagnostics) to compensate for manufacturing variance and aging.

The localization module 425 localizes a position of the client device 410. The localization module 425 may use one or more localization models to localize the position of the client device 410. For example, the localization model may be image-based, configured to determine a position of the client device 410 based on the captured image data from the camera assembly 410. The position of the client device 410 may include information on a position of the client device 410 in relation to the real-world site. In other examples, the localization model is configured to ingest other sensor data, e.g., IMU data, global positioning coordinates, or depth data, to predict the position of the user client device 400. The position of the user client device 400 may include information on a position of the user client device 400 in relation to the real-world site. The position of the user client device 400 may include information on up to 6 degrees-of-freedom (DOF), i.e., three spatial coordinates and three rotational coordinates. Example models for localization of a client device are described in U.S. Application No. 19/303,699 filed on September 12, 2025, U.S. Application No. 18/887,207 filed on September 17, 2024, U.S. Patent No. 12,390,734 issued on August 19, 2025, all of which are incorporated by reference.

The AR developer module 430 includes a suite of one or more tools for authoring of the AR experience. For example, the AR developer module 430 may provide a pre-generated spatial representation of a real-world site. The spatial representation may be generated by scans from one or more camera assemblies. The scans may be leveraged to build the spatial representation, which may describe positions of objects and other surfaces at the real-world site. The AR developer module 430 may also refine the spatial representation based on data received by the client device 410. For example, the AR developer module 430 may receive scans of a portion of the real-world site, which may be fused with the data in the spatial representation.

The AR developer module 430 may further include a library of virtual elements that may be added into the AR experience. These virtual elements may be generated by the developer, or provided by another database. From the database of virtual elements (e.g., 3D models, decals, text, particle systems, audio/haptic cues), the AR developer can select elements to add into an AR experience, with each element being associated with metadata fields defining spatial anchors, spawn rules, behaviors, and dependencies. Elements may be tagged with location descriptors such as latitude/longitude, altitude, coordinate reference system identifiers, geofenced regions (e.g., circular, polygonal, corridor), place identifiers (e.g., points of interest), and indoor references (e.g., floor level, room identifiers), along with constraints on orientation, scale, and visibility. At runtime, the AR developer module 480 resolves these tags using device context (e.g., GNSS coordinates, inertial pose estimates, visual mapping, network-based positioning) to determine when and where elements should spawn, computes world-space transforms, and anchors elements to stable references (e.g., geo-anchors, locally detected surfaces, persistent map features). The AR developer module 430 can further define animations and virtual element behaviors via timelines, state machines, behavior graphs, or scripts, supporting transitions, looping, event-triggered actions, physics interactions, occlusion handling, proximity or gaze responses, and time-of-day or condition-based logic.

The AR developer module 430 may further render the AR experience. The AR developer module 430 may render the AR experience based on the position of the client device 410. The AR experience may include instructions on rendering one or more virtual elements as an augmentation to the captured image data, i.e., AR content. In rendering the AR experience, the AR developer module 430 may render the AR content based on the captured image data, e.g., to match tone, exposure levels, etc. The AR developer module 430 may present the rendered AR content on the display 420.

The interface module 435 generates a user interface on the display 420 for authoring of the AR experience. The interface module 435 may layer the user interface atop the AR experience. The interface module 435 includes one or more options for user input. One option may include typing text, e.g., via an onscreen keyboard. Another option may include drawing text, e.g., via an onscreen notepad. Another option may include recording audio, e.g., via a microphone. The interface module 435 provides the user input and/or any other data gathered by the client device 410 to the server 440 for processing.

In one or more embodiments, the interface module 435 may present, via the user interface, an AI agent, e.g., a chat bot. The user may engage with the AI agent by providing user input, to which the AI agent provides responses based on the user’s input. The interface module 435 may provide the user input to the server 440 for performing one or more natural language processing tasks to generate responses to the user’s input.

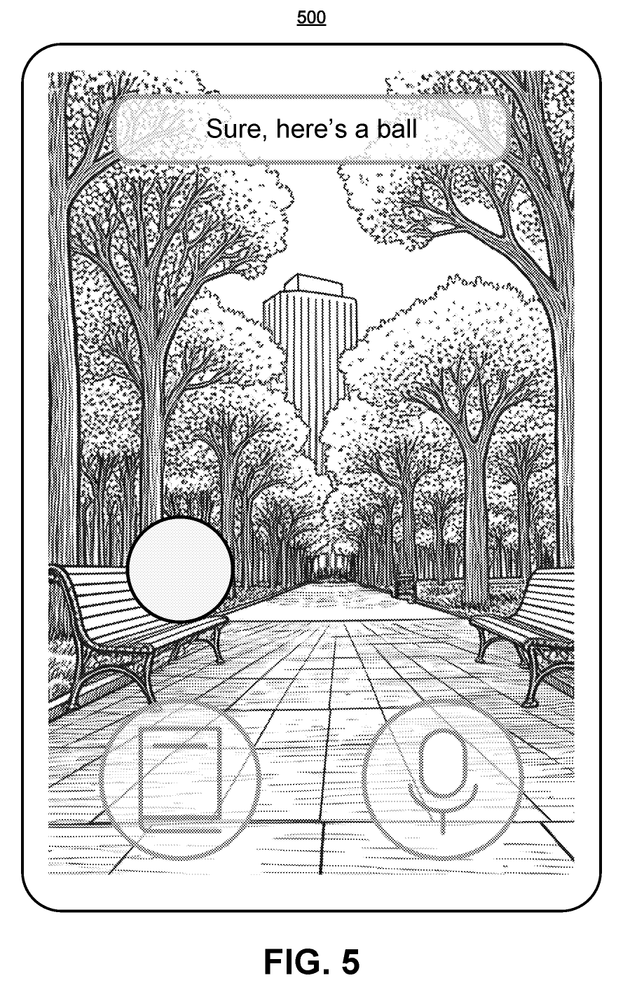

FIG. 5 illustrates an example user interface 500 for in-situ authoring of an AR experience, according to one or more embodiments. The user interface may present a live feed of the camera, augmented with some virtual elements. Layered atop the live feed, the user interface may include one or more options for assistance in the authoring workflow. For example, the user interface may include two options, represented by the book symbol virtual button and the microphone symbol virtual button. In response to the user selection of the book symbol option, the user interface may present an onscreen keyboard for typing text. In response to the user selection of the microphone symbol option, the user interface may begin recording audio, e.g., speech by the user. The user interface 500 may further include a speech bubble, e.g., presented at the top of the user interface. The speech bubble may be used to provide agentic responses to the user’s inputs, e.g., in embodiments leveraging an AI agent.

Returning to FIG. 4, the server 440 performs analyses to assist the user in authoring of the AR experience. The server 440 is a computing device, which may be connected to the client device 410, e.g., via the network 495. The server 440 may include a scene understanding module 445, a prompt module 450, a large language model 455, an asset generation module 460, an interface module 465, and a database 470. In other embodiments, the server 440 may include additional, fewer, or different modules.

The scene understanding module 445 performs one or more analyses to understand the real-world site. The scene understanding module 445 may perform these analyses by applying various models to the captured data from the client device 410. For example, the scene understanding module 445 may apply a localization model to determine a pose of each frame in captured image data. The scene understanding module 445 may build a spatial representation (e.g., a point cloud or a mesh) of the real-world site based on the captured image data and the pose data. The scene understanding module 445 may further ingest inertial measurement unit (IMU) data or other motion data (e.g., from visual odometry) in generating the spatial representation. The scene understanding module 445 may apply a segmentation module to segment pixels into one or more classifications. The scene understanding module 445 may apply an object detection module to classify objects in the scene. The scene understanding module 445 may provide the spatial representation back to the client device 410, e.g., for use in authoring the AR experience.

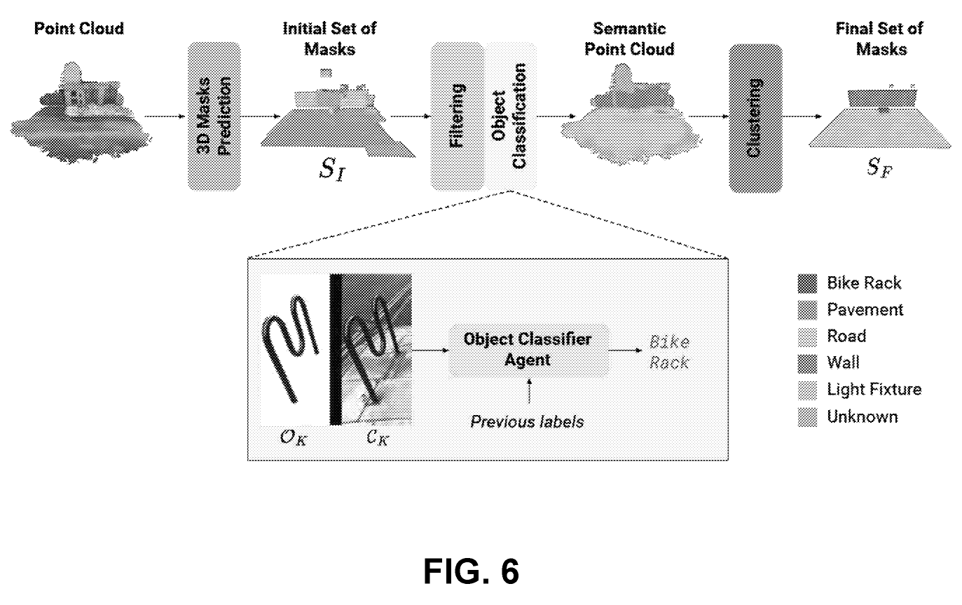

FIG. 6 illustrates an example workflow for scene understanding, according to one or more embodiments. This example workflow may be performed by the scene understanding module 445.

In various embodiments, the scene understanding module 445 ingests raw capture data from an on-site client device and constructs a three-dimensional point cloud of the environment. The module can fuse multi-view RGB frames, LiDAR or time-of-flight depth, device pose estimates, or some combination thereof to produce a point cloud. The point cloud may include information on surface normals and confidence scores. Pre‑processing may remove personally identifiable imagery (e.g., faces, license plates), fill missing depth using monocular depth inference re‑scaled against reliable metric depth samples, generate occlusion maps for later use by AR rendering, or some combination thereof. The scene understanding module 445 may normalize to a site coordinate frame.

The scene understanding module 445 may detect a ground plane. In various embodiments, a system detects a ground plane from a point cloud by preprocessing to downsample and remove outliers, selecting low-elevation seed points, and fitting one or more planes with robust estimators (e.g., RANSAC or normal-based region growing) subject to a gravity-alignment constraint, followed by least-squares refinement and region growth to expand inliers. To accommodate slopes and multi-level terrain, the system performs multi-pass extraction or tiled piecewise planar fitting, merges adjacent patches with similar parameters, and retains planes whose normals are near horizontal and whose spatial extent and inlier counts exceed configurable thresholds. For large outdoor scenes, the system may project points to an elevation grid and apply morphological filtering to separate ground from elevated objects, validating results using residual error, coverage, and normal alignment to produce a labeled ground set for downstream mapping and AR modules. The scene understanding module 445 may also partition the point cloud into tiles to support scalable processing.

In one or more embodiments, the scene understanding module 445 performs 3D object detection to infer instance masks over points in the input cloud, producing an initial set of masks S_{I}. A mask proposal network assigns, for each candidate instance, a binary membership over points with per‑mask metadata including extent, pose, and confidence. Because the instance masks may contain overlapping or low‑quality instances, the scene understanding module 445 applies filtering based on point density, compactness, normal variance, planar fit residuals, overlap (e.g., intersection‑over‑union thresholds) to prune spurious masks, or some combination thereof. The scene understanding module 445 may further split disconnected components, or merge overlapping proposals. The result is a cleaned subset of 3D instances suitable for semantic labeling.

In one or more embodiments, the scene understanding module 445 executes object classification for the filtered masks using an object classifier. For each instance mask k, the scene understanding module 445 computes an object‑aligned crop Oₖ and a context crop Cₖ from the camera frame Iₖ with highest visibility, guided by point sampling and visibility checks against monocular and metric depth maps. The object classifier consumes Oₖ, Cₖ, and previously assigned labels to output a semantic category for the object. In some embodiments, the object classifier leverages a large language model that inputs the object and outputs the semantic category. The object classifier may further output calibrated confidence and optional synonyms that are normalized to the canonical taxonomy. By ingesting previously assigned labels in the scene, the object classifier improves cross‑scene consistency. The assigned label for mask k is then propagated to all points within the mask to form a semantic point cloud.

In one or more embodiments, the scene understanding module 445 generates the semantic point cloud and consolidates instances via clustering to obtain a final set of masks S_{F}. Clustering may use density‑based methods (e.g., HDBSCAN), spatial connectivity, geometric regularizers, or some combination thereof to join fragments of the same object while preserving boundaries between adjacent instances. The scene understanding module 445 computes canonical geometry and pose per instance, labels points not covered by any instance as unknown, and stores per‑point attributes such as class identifier, occlusion tags, and local surface parameters. S_{F} typically contains fewer, cleaner instances than S_{I} because multiple proposals referring to the same physical object are clustered together and refined.

In one or more embodiments, the scene understanding module 445 constructs a scene graph from S F by deriving labeled 3D bounding boxes and associating them with anchors and affordances used by AR applications. The graph stores instance identifiers, class labels, world‑space transforms, and links to evidence (e.g., source crops Ok or C kand confidence metrics) and can be serialized with versioning and provenance for audit and re‑use. During deployment, AR systems utilize the scene graph to place virtual content on semantically appropriate surfaces (e.g., Pavement or Wall), enforce safety geofences (e.g., avoid Road), and apply occlusion using reconstructed geometry. Processing may be executed offline on accelerator hardware, with results cached and distributed to client devices.

In one or more embodiments, the scene understanding module 445 interfaces with a visual positioning system (VPS) to re‑localize users within the precomputed scene. When a user returns to the site, the client captures a reference image (and optional coarse location), and the VPS computes the device pose relative to the mapped environment. The scene understanding module 445 aligns the live pose to the scene graph coordinate frame, ensuring that virtual elements remain correctly registered with real‑world objects identified in S F. This integration enables multi‑user consistency at the same location, supports incremental updates when new scans are added, and provides robustness to occlusion and environmental changes by grounding AR experiences in the semantic structure of the environment.

The prompt module 450 generates one or more prompts for execution by the large language model 455. The prompt module 450 may include a template of prompts that are tailored based on the user input. In one or more embodiments, the prompt module 450 may perform prompt boosting, to augment the user input. For example, the prompt module 450 may include in the prompt additional instructions for generation of some virtual element based on the user’s input. The prompt boosting may incorporate visual examples for generating text expanding on visual characteristics of the desired virtual element. In some embodiments, the prompt boosting also incorporates the extracted information from the spatial representation, e.g., semantic labeling, object classification, masks, etc. The prompt module 450 provides the prompt to the large language model 455 for execution. In other embodiments, the workflow leverages another type of generative model.

The large language model 455 is an AI model trained to output responses based on an input prompt. The LLM 455 is trained on massive datasets of text and code, to learn patterns and relationships within human language. The LLM 455 may be tuned to perform specific natural language processing tasks. In some embodiments, the LLM 455 may be trained as an agentic model, providing human-like responses to user input, simulating a conversation. In some embodiments, the LLM 455 may be trained as a multimodal model, configured to input and/or output different modes of data (e.g., text, audio, video, image, computer code, etc.). For example, the LLM 445 may be configured to receive text-based prompts to generate novel images. In another example, the LLM 455 may be configured to receive voice-based prompts to modify virtual elements in the AR experience.

In various embodiments, the LLM 455 is a neural network configured to process sequences of tokens and generate contextually coherent text, commands, or structured outputs. The LLM 455 may employ transformer-based architectures, including encoder-decoder or decoder-only stacks with multi-head self-attention, feed-forward layers, normalization, and learned token and positional embeddings. Tokens can be produced by subword segmentation schemes (e.g., BPE or SentencePiece), and the model may support extended context windows via attention optimizations and key–value caching. Deployment can include hosted inference services executed on accelerator hardware (e.g., GPUs, TPUs) with tensor and pipeline parallelism, mixed-precision arithmetic (e.g., FP16/BF16), and optional quantization (e.g., INT8/INT4) to reduce latency and memory footprint. A serving layer may provide batched and streaming endpoints over HTTP/gRPC, perform request routing and load balancing, and apply safety filters, rate limits, and audit logging. Versioning controls and rollout policies enable blue/green or canary deployments, while observability components collect performance, accuracy, and drift metrics to guide scaling and updates. In certain implementations, the LLM 455 integrates with retrieval systems (e.g., vector indexes) to augment responses with external knowledge and can run partially on-device for privacy-sensitive tasks using compact or distilled variants.

Training the LLM 455 may comprise large-scale self-supervised pretraining and task-directed finetuning. Pretraining can utilize heterogeneous corpora curated with deduplication, quality and toxicity filtering, and source attribution, optimizing objectives such as causal language modeling or masked token prediction with distributed stochastic gradient descent (e.g., AdamW/Adafactor), learning-rate schedules with warmup and decay, gradient clipping, and checkpointing for fault tolerance. Finetuning for particular NLP tasks may employ supervised datasets and instruction-style exemplars to align outputs to task specifications, including but not limited to question answering, summarization, dialogue, intent classification, named-entity recognition, sentiment analysis, code generation, and information extraction. Parameter-efficient methods such as adapters, LoRA, prefix/prompt tuning, or low-rank updates allow domain adaptation with limited compute while preserving general capabilities; alternatively, full-model updates or multi-task training can be used when higher capacity is required. Post-training alignment may incorporate preference optimization or human feedback to refine response helpfulness and safety. Evaluation can include perplexity and task-specific metrics (e.g., ROUGE, BLEU, F1, accuracy), robustness tests, and calibration assessments, with continuous monitoring to detect dataset drift and trigger refinement or data refresh. Integration hooks enable the finetuned model to enforce schema constraints, produce structured outputs (e.g., JSON), and interoperate with downstream applications through standardized APIs.

The asset generation module 460 receives user input describing a desired virtual object to generate the virtual object for inclusion in an AR experience. The asset generation module 460 receives the user input, e.g., speech captured via a microphone (transcribed to text), free‑form text, or supplemental sketches/photos, and converts the input into a normalized textual specification that includes semantic tags (e.g., category, style, scale, materials, behaviors) using a language model to expand, disambiguate, and constrain the description to an internal taxonomy. In one or more embodiments, the asset generation module 460 may perform prompt boosting by inclusion of visual examples to expand the user’s input to form an expanded prompt. The module then leverages a text‑to‑image generative model (e.g., diffusion or transformer‑based model) to synthesize one or more 2D reference images. The asset generation module 460 may produce multi‑view renders, segmentation masks, depth cues, or some combination thereof. Then the asset generation module 460 applies an image‑to‑3D generative model that converts the selected 2D reference images into a 3D representation, e.g., a polygonal mesh with textures, a point cloud, or an implicit field (e.g., SDF/NeRF). The asset generation module 460 may perform post‑processing including retopology, decimation, collision proxy generation, rigging/animation hooks, level‑of‑detail packaging, or some combination thereof to meet runtime constraints and align to a site coordinate frame. In some embodiments, the generative models used at one or more stages are large language models (LLMs) or multimodal foundation models that plan steps, generate prompts, evaluate intermediate artifacts, and emit structured metadata for the asset.

In one or more embodiments, the asset generation module 460 employs a singular multimodal model that takes the user input and directly outputs a 3D virtual object. In other embodiments, the asset generation module 460 employs a singular model that is iteratively queried for each stage (e.g., prompt boosting, 2D imagery generation, and 3D geometry generation) with stage‑specific prompts and parameters, thereby producing consistent assets with traceable provenance that can be versioned, reviewed, and deployed into AR experiences.

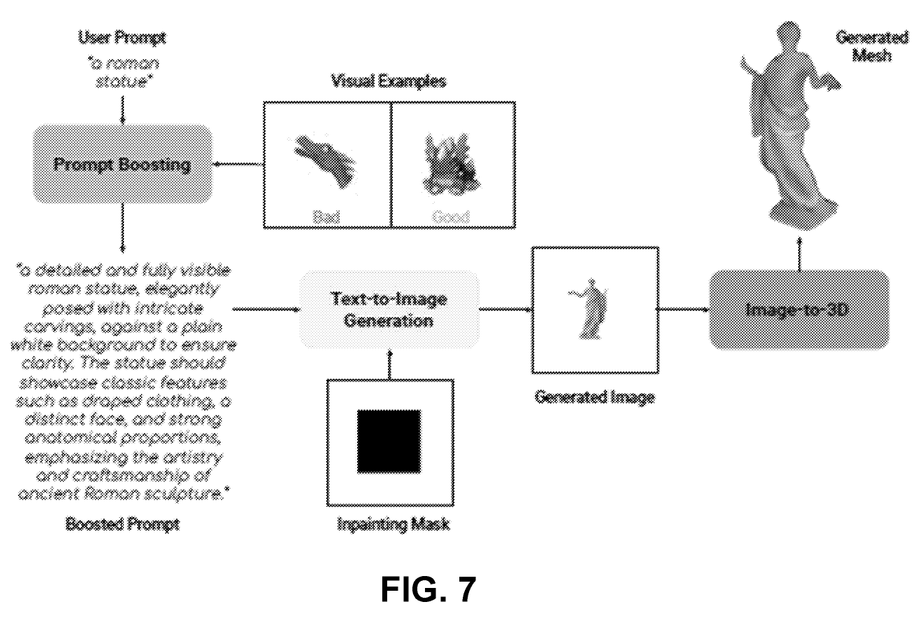

FIG. 7 illustrates an example workflow for LLM-assisted content generation, according to one or more embodiments. The example workflow may leverage one or more models for generation of the virtual content. Based on a user input, the workflow may include prompt boosting to augment the user’s input. For example, the user prompt was “a roman statue.” Based on that input, the prompt boosting can leverage training data for augmentation of the prompt. For example, the prompt boosting turns the simple prompt into “A detailed and fully visible roman statue, elegantly posed with intricate carvings, against a plain white background, to ensure clarity. The statue should showcase classic features such as draped clothing, a distinct face, and strong anatomical proportions, emphasizing the artistry and craftsmanship of ancient Roman sculpture.” The training data for augmentation of the prompt may include visual examples, optionally paired with textual descriptions of the visual examples. The workflow feeds the boosted prompt into a text-to-image generator, e.g., a LLM. The LLM may use an inpainting mask to output the generated image, generated in response to the boosted prompt. The workflow provides the generated image to another image-to-3D model to generate a mesh for the virtually-generated image. The 3D mesh may then be placed into the AR experience.

Returning to FIG. 4, the interface module 465 provides an interface between the client device 410 and the components of the server 440. The interface module 465 may receive the user input from the interface module 435, which then provides the user input to the prompt module 450 for generating prompts for execution by the LLM 455. The responses by the LLM 455, may be provided back to the interface module 435 of the client device 410.

The database 470 stores data used by the server 440 and/or the client device 410. For example, the database 470 may store libraries of virtual elements that may be used in authoring the AR experience. The database 470 may store spatial representations of different real-world sites. When another user visits the real-world site, the user may retrieve previously generated spatial representations (i.e., cached in the database 470) for use in authoring their own AR experience. The database 470 may also store AR experiences generated by users. The users may, through the server 440, share their authored AR experiences to other users.

### EXAMPLE METHOD

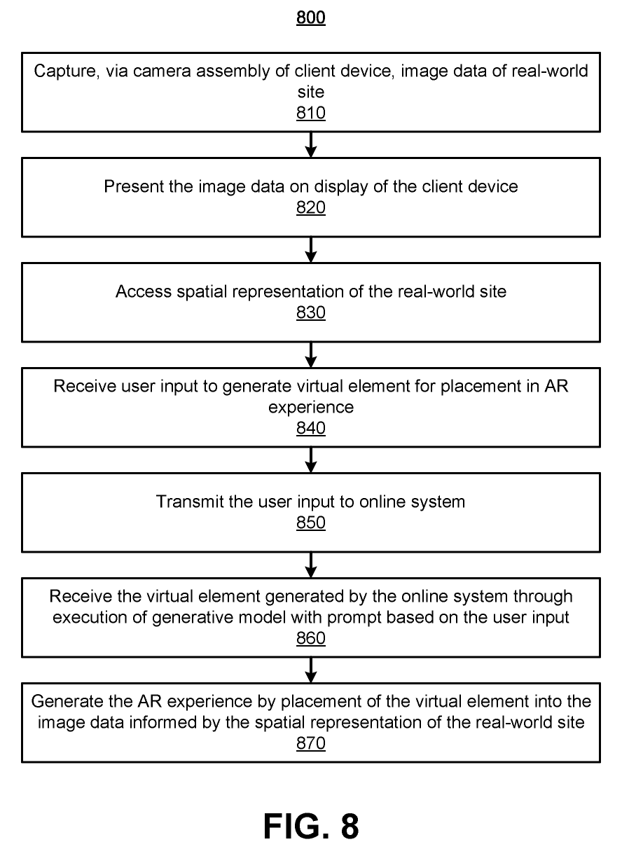

FIG. 8 illustrates a method flowchart describing a process 800 of AI-assisted on-site authoring of an AR experience, according to one embodiment. The process 800 may be performed by an on-site client device (e.g., the client device 410 of FIG. 4). In other embodiments, one or more steps of the process 800 may be performed by another computing device. In other embodiments, the process 800 may include additional, fewer, or different steps than those listed herein.

The device captures 810, via a camera assembly of the client device, image data of a real-world site. In some embodiments, the camera assembly produces timestamped RGB frames and depth measurements (e.g., LiDAR or time‑of‑flight) synchronized with device pose, and the device performs preprocessing such as lens distortion correction, exposure and white‑balance control, denoising, and calibration to a site coordinate frame. The capture pipeline may buffer keyframes and associated metadata (e.g., intrinsic/extrinsic parameters, localization confidence) for use in downstream spatial reconstruction and semantic analysis.

The device presents 820 the image data on a display of the client device. The presentation may include controls for reviewing captured frames, quality indicators (e.g., focus and motion blur), and overlays showing capture coverage to guide the user in collecting sufficient views of the site. In certain implementations, the device renders the image data alongside status panels for sensor health and storage availability, enabling the user to confirm that the capture is adequate for generating a spatial representation.

The device accesses 830 a spatial representation of the real-world site. In some embodiments, accessing the spatial representation of the real-world site comprises transmitting the image data to an online system and receiving the spatial representation generated by the online system based on the image data. In other embodiments, accessing the spatial representation of the real-world site comprises generating, by the client device, the spatial representation by projecting objects from the image data into a three-dimensional coordinate frame, for example by estimating device pose, reconstructing a point cloud or mesh, and computing per‑point normals. In certain implementations, the spatial representation comprises semantic labeling of objects in the real-world site, where the semantic labeling of the objects is generated by predicting a plurality of instance masks from the spatial representation representing the objects in the real-world site, applying an open‑vocabulary object classifier to each instance mask to output a semantic label for the instance mask, and clustering one or more overlapping instance masks corresponding to one object to yield a final set of instance masks corresponding to the objects in the spatial representation. In some embodiments, the online system may perform offline generation of the spatial representation from other image data captured by at least one other device. The online system may fuse data from various streams to generate the spatial representation.

The device receives 840 user input to generate a virtual element for placement in an AR experience. In some embodiments, receiving the user input to generate the virtual element for placement in the AR experience comprises capturing, by a microphone of the client device, speech by the user, which the device transcribes to text and enriches with semantic tags. In other embodiments, receiving the user input to generate the virtual element for placement in the AR experience comprises receiving text input via a touchscreen display, optionally supplemented by sketches or photos, and normalizing the input to an internal schema describing category, style, materials, scale, and intended behavior of the virtual element.

The device transmits 850 the user input to an online system. Prior to transmission, the device may generate a prompt based on a template comprising instructions for generation of one or more reference images of the virtual element. The instructions may provide guidance on viewpoints, lighting, and style constraints. In some embodiments, generating the prompt comprises generating the prompt to include semantic labeling of the one or more objects in the real-world site as context so that the virtual element is compatible with local surroundings (e.g., avoiding placement on Road and aligning textures to Pavement or Wall). The device packages the prompt with captured metadata (e.g., coordinate frame and scale) and sends the prompt to the online system.

The device receives 860 the virtual element generated by the online system through execution of a generative with a prompt based on the user input. In one or more embodiments, the online system executes a generative model on the prompt to output the three-dimensional structure of the virtual element. The generative process may be a single generative step, generating the three-dimensional structure from a singular prompt. The output may include a textured mesh, UV maps, collision proxies, level‑of‑detail variants, or some combination thereof—suitable for real‑time rendering.

In various embodiments, the online system performs multi-stage generation, to generate the three-dimensional structure. In a first generative step, the online system executes a generative model (e.g., which may be a large language model or multimodal foundation model) on a prompt to generate one or more reference images of the virtual element. At a second generative step, the online system generates a three-dimensional structure of the virtual element based on the one or more reference images. The online system may leverage the same generative model, or a different generative model in the second generative step. In some embodiments, the online system may further perform prompt boosting to generate an expanded description of the desired virtual element.

The device generates 870 the AR experience by placement of the virtual element into the image data informed by the spatial representation of the real-world site. Placement can include computing an anchor transform from the semantic point cloud or labeled masks, enforcing geofences and safety rules (e.g., exclude Road), and applying occlusion, scale, and lighting estimation to achieve visual coherence. The device may validate the placement against the spatial representation (e.g., surface normal and extent checks), adjust behavior and animations based on local context, render the updated scene to the user, or some combination thereof. In effect, the coordination with the generative capabilities of the online system empower the on-site client device to perform in-situ authoring of the AR experience, completing a closed loop from capture through generation and contextual deployment of the virtual element.

The device renders the AR experience on the display by compositing virtual elements over the live camera view while maintaining accurate registration to the real-world scene. To achieve alignment, the device estimates pose using visual-inertial tracking and applies world-space transforms derived from anchors in a spatial representation, then computes per-frame occlusion masks from depth maps or semantic geometry so virtual objects are correctly hidden behind real surfaces. The rendering engine performs lighting estimation from the camera feed to drive shading, reflections, and shadowing, adapts level-of-detail and animation rates to meet target frame times, and executes physics or behavior graphs governing interactions with detected surfaces and user input. The device overlays UI controls and diagnostics, synchronizes timestamps across sensors and graphics, and leverages the GPU to schedule passes for color, depth, post-processing, and transparency to produce a stable, visually coherent AR scene.

The device iterates on design of the AR experience by leveraging AI-assisted functionality that refines assets, placement, and behavior in response to prompts, telemetry, and user feedback. The device enables the user or developer to submit natural-language updates describing desired changes, which an LLM or multimodal generative model converts into revised prompts, alternative reference images, or 3D asset variations; the device stages candidate updates, simulates them against captured frames and the spatial representation, and proposes rollouts with side-by-side previews and metrics such as alignment error, occlusion quality, frame rate, and user engagement. The device can perform iterative loops where the AI suggests parameter tweaks (e.g., spawn rules, materials, animations) and checks compliance with safety geofences and semantic constraints, with accepted changes versioned, signed, and applied atomically so the user can immediately evaluate the revised AR experience and continue refinement.

The device provides the AR experience to another computing system or device by packaging the experience into a distribution bundle containing assets, transforms, anchors, behavior definitions, and policy metadata, and transmitting the bundle over authenticated, encrypted channels. The device supports both synchronized sharing for multi-user sessions and handoff for remote rendering, using protocols such as WebRTC or application APIs to stream live views, state updates, and incremental patches while maintaining a common coordinate frame via visual positioning or shared anchors. On receipt, the other system reconstructs the scene context and renders the AR experience locally, with the originating device coordinating permissions, version control, and conflict resolution, and optionally continuing to supply occlusion geometry, lighting hints, and asset deltas to keep both devices in visual and behavioral lockstep.

### EXAMPLE COMPUTING SYSTEM

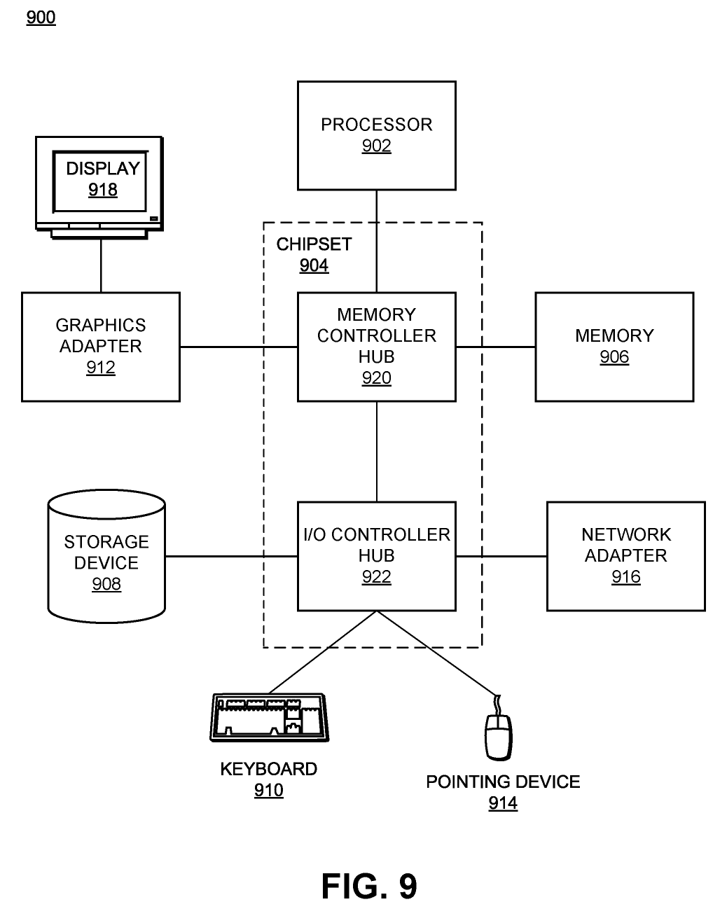

FIG. 9 is an example architecture of a computing device, according to an embodiment. Although FIG. 9 depicts a high-level block diagram illustrating physical components of a computer used as part or all of one or more entities described herein, according to an embodiment, a computer may have additional, less, or variations of the components provided in FIG. 9. Although FIG. 9 depicts a computer 900, the figure is intended as functional description of the various features which may be present in computer systems than as a structural schematic of the implementations described herein. In practice, and as recognized by those of ordinary skill in the art, items shown separately could be combined and some items could be separated.

Illustrated in FIG. 9 are at least one processor 902 coupled to a chipset 904. Also coupled to the chipset 904 are a memory 906, a storage device 908, a keyboard 910, a graphics adapter 912, a pointing device 914, and a network adapter 916. A display 918 is coupled to the graphics adapter 912. In one embodiment, the functionality of the chipset 904 is provided by a memory controller hub 920 and an I/O hub 922. In another embodiment, the memory 906 is coupled directly to the processor 902 instead of the chipset 904. In some embodiments, the computer 900 includes one or more communication buses for interconnecting these components. The one or more communication buses optionally include circuitry (sometimes called a chipset) that interconnects and controls communications between system components.

The storage device 908 is any non-transitory computer-readable storage medium, such as a hard drive, compact disk read-only memory (CD-ROM), DVD, or a solid-state memory device or other optical storage, magnetic cassettes, magnetic tape, magnetic disk storage or other magnetic storage devices, magnetic disk storage devices, optical disk storage devices, flash memory devices, or other non-volatile solid state storage devices. Such a storage device 908 can also be referred to as persistent memory. The pointing device 914 may be a mouse, track ball, or other type of pointing device, and is used in combination with the keyboard 910 to input data into the computer 900. The graphics adapter 912 displays images and other information on the display 918. The network adapter 916 couples the computer 900 to a local or wide area network.

The memory 906 holds instructions and data used by the processor 902. The memory 906 can be non-persistent memory, examples of which include high-speed random-access memory, such as DRAM, SRAM, DDR RAM, ROM, EEPROM, flash memory.

As is known in the art, a computer 900 can have different and/or other components than those shown in FIG. 9. In addition, the computer 900 can lack certain illustrated components. In one embodiment, a computer 900 acting as a server may lack a keyboard 910, pointing device 914, graphics adapter 912, and/or display 918. Moreover, the storage device 908 can be local and/or remote from the computer 900 (such as embodied within a storage area network (SAN)).

As is known in the art, the computer 900 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 908, loaded into the memory 906, and executed by the processor 902.

### ADDITIONAL CONSIDERATIONS

Some portions of above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a computer system and a computerized process. Thus, while particular embodiments and applications have been illustrated and described, it is to be understood that the described subject matter is not limited to the precise construction and components disclosed herein and that various modifications, changes and variations which will be apparent to those skilled in the art may be made in the arrangement, operation and details of the method and apparatus disclosed. The scope of protection should be limited only by the following claims.

What is claimed is:

1. A computer-implemented method comprising:
capturing, via a camera of a client device, image data of a real-world site;
presenting the image data on a display of the client device;
accessing a spatial representation of the real-world site;
receiving user input to generate a virtual element for placement into an augmented reality (AR) experience;
transmitting the user input to an online system;
receiving the virtual element generated by an online system through execution of a generative model with a prompt based on the user input; and
generating the AR experience by placement of the virtual element informed by the spatial representation of the real-world site.

2. The computer-implemented method of claim 1, wherein accessing the spatial representation of the real-world site comprises:
transmitting the image data to the online system;
receiving the spatial representation generated by the online system based on the image data.

3. The computer-implemented method of claim 1, wherein accessing the spatial representation of the real-world site comprises:
generating, by the client device, the spatial representation by projecting objects from the image data into a three-dimensional coordinate frame.

4. The computer-implemented method of claim 1, wherein the spatial representation is generated off-line from other image data captured by at least one other device.

5. The computer-implemented method of claim 1, wherein the spatial representation comprises semantic labeling of objects in the real-world site.

6. The computer-implemented method of claim 5, wherein the semantic labeling of the objects is generated by:
predicting a plurality of instance masks from the spatial representation representing the objects in the real-world site;
applying an open-vocabulary object classifier to each instance mask to output a semantic label for the instance mask; and
clustering one or more overlapping instance masks corresponding to one object to yield a final set of instance masks corresponding to the objects in the spatial representation.

7. The computer-implemented method of claim 1, wherein receiving the user input to generate the virtual element for placement in the AR experience comprises:
capturing, by a microphone of the client device, speech by the user.

8. The computer-implemented method of claim 1, wherein receiving the user input to generate the virtual element for placement in the AR experience comprises:
receiving text input via a touchscreen display.

9. The computer-implemented method of claim 1, wherein the virtual element is generated by:
generating the prompt based on a template comprising instructions to generate a three-dimensional structure of the virtual element based on the user input; and
executing the generative model on the prompt to generate the three-dimensional structure of the virtual element.

10. The computer-implemented method of claim 1, wherein the virtual element is generated by:
generating the prompt based on a template comprising instructions for generation of one or more reference images of the virtual element;
executing the generative model on the prompt to generate the one or more reference images of the virtual element; and
generating a three-dimensional structure of the virtual element based on the one or more reference images.

11. The computer-implemented method of claim 10, wherein generating the prompt comprises:
generating the prompt comprising semantic labeling of the one or more objects in the real-world site as context.

12. The computer-implemented method of claim 10, wherein generating the three-dimensional structure of the virtual element comprises:
generating a subsequent prompt comprising the one or more reference images and instructions to generate the three-dimensional structure; and
executing the generative model on the subsequent prompt to generate the three-dimensional structure.

13. A non-transitory computer-readable storage medium comprising instructions that, when executed, cause a client device to perform operations comprising:
capturing, via a camera of the client device, image data of a real-world site;
presenting the image data on a display of the client device;
accessing a spatial representation of the real-world site;
receiving user input to generate a virtual element for placement into an augmented reality (AR) experience;
transmitting the user input to an online system;
receiving the virtual element generated by an online system through execution of a generative model with a prompt based on the user input; and
generating the AR experience by placement of the virtual element informed by the spatial representation of the real-world site.

14. The non-transitory computer-readable storage medium of claim 13, wherein accessing the spatial representation of the real-world site comprises:
transmitting the image data to the online system;
receiving the spatial representation generated by the online system based on the image data.

15. The non-transitory computer-readable storage medium of claim 13, wherein accessing the spatial representation of the real-world site comprises:
generating, by the client device, the spatial representation by projecting objects from the image data into a three-dimensional coordinate frame.

16. The non-transitory computer-readable storage medium of claim 13, wherein the spatial representation is generated off-line from other image data captured by at least one other device.

17. The non-transitory computer-readable storage medium of claim 13, wherein the spatial representation comprises semantic labeling of objects in the real-world site.

18. The non-transitory computer-readable storage medium of claim 17, wherein the semantic labeling of the objects is generated by:
predicting a plurality of instance masks from the spatial representation representing the objects in the real-world site;
applying an open-vocabulary object classifier to each instance mask to output a semantic label for the instance mask; and
clustering one or more overlapping instance masks corresponding to one object to yield a final set of instance masks corresponding to the objects in the spatial representation.

19. The non-transitory computer-readable storage medium of claim 13, wherein receiving the user input to generate the virtual element for placement in the AR experience comprises:
capturing, by a microphone of the client device, speech by the user; or
receiving text input via a touchscreen display.

20. The non-transitory computer-readable storage medium of claim 13, wherein the virtual element is generated by:
generating the prompt based on a template comprising instructions to generate a three-dimensional structure of the virtual element based on the user input; and
executing the generative model on the prompt to generate the three-dimensional structure of the virtual element.

21. The non-transitory computer-readable storage medium of claim 13, wherein the virtual element is generated by:
generating the prompt based on a template comprising instructions for generation of one or more reference images of the virtual element;
executing the generative model on the prompt to generate the one or more reference images of the virtual element; and
generating a three-dimensional structure of the virtual element based on the one or more reference images.

22. The non-transitory computer-readable storage medium of claim 21, wherein generating the three-dimensional structure of the virtual element comprises:
generating a subsequent prompt comprising the one or more reference images and instructions to generate the three-dimensional structure; and
executing the generative model on the subsequent prompt to generate the three-dimensional structure.
